(19) United States
(12) Patent Application Publication
(10) Pub. No.: US 2003/0212821 A1
(43) Pub. Date: Nov. 13, 2003

(54) System and method for routing packets in a wired or wireless network

(75) Inventors: Donald W. Gillies, San Diego, CA (US); Weilin Wang, San Diego, CA (US); Michael P. Nova, Del Mar, CA (US)

Correspondence Address: PROCOPIO, CORY, HARGREAVES & SAVITCH LLP, 530 B STREET, SUITE 2100, SAN DIEGO, CA, 92101, US

(73) Assignee: Kiyon, Inc.

(21) Appl. No.: 10/437,129

(22) Filed: May 13, 2003

Related U.S. Application Data
(60) Provisional application No. 60/380,425, filed on May 13, 2002.

(51) Int. Cl. G06F 15/173

(52) U.S. Cl. 709/238

(57) ABSTRACT

A system and method for routing packets over wireless and wired networks is presented. The system employs an attribute routing scheme that routes communication packets that include objects containing network optimization parameters that are used to control the physical links in the network. The routing transport protocol is logically separated from the objects that are routed, which allows objects having new optimization parameters beyond the conventional network topology parameters or network link parameters to be defined and propagated throughout the network. Additionally, new dynamic routing objects of arbitrary size can be defined that have a customizable update period. These dynamic routing objects are propagated through the network based on their respective custom update periods. The system also includes a feature that enables exponential backoff in the custom update periods. Updates may also be linked to one another, enabling network clients to query the network for related information resulting in efficient implementation of a networking system.

### RELATED APPLICATION

The present application claims priority to U.S. provisional patent application serial No. 60/380,425 filed on May 13, 2002, which is incorporated herein by reference in its entirety.

### BACKGROUND

1. Field of the Invention

The present invention generally relates to digital data (text, audio, images, and audio-video) transmission in a wireless or wired network and more specifically relates to multi-hop and mesh routing systems comprising a routing protocol and one or more device specific adaptation protocols.

2. Related Art

Conventional routing protocols can be classified as either ad-hoc or traditional, depending on whether they compute routes on-demand or proactively. In terms of a conventional protocol stack, routing is typically performed in the network layer (e.g., IP, XNS, IPX), however some systems route at the media access control (“MAC”) layer, for example the Graviton Routing Information Protocol (“GRIP”). Still other systems route at the application layer, for example the Clearinghouse system or the Akamai FreeFlow system.

Ad-hoc systems of this type include the Ad-Hoc On-demand Distance Vectoring (“AODV”) protocol and GRIP. These systems typically broadcast packets to intermediate nodes that learn paths to the broadcaster as the packet passes through the network. In the AODV protocol, the goal of a broadcast is to establish a linear path route from the original source node to the original destination node. By default, an intermediate node will forward a routing broadcast packet and suppress any duplicate broadcast packets, using a nontrivial sequence numbering scheme. However, if an intermediate node already knows a route to the destination, it is allowed to send an early response packet to the source node, indicating hop-count and path information that traces from the destination node back to the source node.

There are some disadvantages to the AODV routing scheme. The AODV protocol uses a network-wide broadcast, or an expanding-ring broadcast, to discover routes. Any on-demand routing protocol in the worst case must use a network-wide broadcast to repair routes. However, the amount of improvement in the routing tables is not justified by the expense of a network-wide broadcast. Every node in the network is burdened with receiving and forwarding or suppressing several copies of the broadcast packet. These broadcasts consume excessive amounts of network bandwidth for the information they discover.

The GRIP protocol is more efficient. Whereas AODV is intended to establish and refresh routing tables along a linear set of nodes, GRIP is designed to establish and refresh routing tables in a rooted tree that covers all or part of the network. The reason for this design decision is simple: both protocols (AODV and GRIP) will need to flood the network in the worst case to establish routes. Since a flood is impossible to avoid it makes sense to learn as much as possible from the flood. A worst-case analysis can show that an AODV expanding ring broadcast, in a network of N nodes, yields O(1/N) usable routing table entries per broadcast packet forwarding event. The same worst-case analysis shows that GRIP learns O(1) routing table entries per broadcast packet forwarding event. Therefore, GRIP is O(N) times more efficient than AODV. In a mesh network of sensors, a sensor node will likely have zero or more external network attachment points and one or more control nodes that all desire full routing connectivity to the sensor mesh. In such a system, these nodes can broadcast on-demand, or periodically, and all the routes learned are likely to be used by actual network traffic.

Importantly, all these protocols can be classified as on-demand, flood/discovery systems. This means that they use a multi-hop network flood to configure information in remote nodes and to pull information back from the remote nodes.

Traditional routing systems employ a two-layer propagation scheme. The primary algorithm is the triggered update. The triggered update causes new routing information to be propagated whenever the system topology changes. This is a performance enhancement in accordance with the end-to-end argument in system design. The secondary algorithm is the reliable update. This update causes the routing tables to be periodically transferred to neighbor nodes. The secondary algorithm solves the problems of lost triggered updates.

All traditional protocols treat the network interface card (“NIC”) as a self-configuring black-box device. Traditional protocols will measure the performance of the black box NIC, but they will not attempt to modify the communications parameters of the NIC black box based on routing information. Load-balancing traditional protocols attempt to shift communications load among different black box NICs based on measured performance parameters.

Examples of traditional network layer routing protocols include the Routing Information Protocol (“RIP”), RIP2, RIP2-IPX, RIP2-RTMP, Digital Equipment Corporation network (“DECNet”), Open Shortest Path First (“OSPF”), Intermediate System to Intermediate System (“ISIS”), Enhanced Interior Gateway Routing Protocol (“EIGRP”), and Border Gateway Protocol (“BGP”), just to name a few. These conventional systems suffer from various drawbacks including a limit of one address type per protocol, and a limited set of distance metrics, and the inability to carry RF signal strength or RF channel information. In all such protocols there are two fixed update timeouts, the secondary period and the timeout period. The secondary period is typically 30-90 seconds in distance vector protocols and 30 minutes in link-state protocols. The timeout period is typically 180 seconds in distance vector protocols and 60 minutes in link-state protocols. Because these timeouts are fixed, long-lived data cannot be transported efficiently, or in some cases (e.g., clock sync), cannot be transported at all. These are significant drawbacks.

EIGRP is a state-of-the-art distance vectoring protocol, with a number of beneficial features. First, it uses four metrics for path quality (“goodness”), and then calculates a composite goodness value. So a path with goodness 1 might get three times more traffic than a path with goodness 3. However, this traffic-spreading heuristic will confuse many virtual circuit protocols because it will sometimes deliver packets out of order. Second, EIGRP allows several default routes to remote networks (e.g., the Internet). Each routing entry can potentially have a default route flag turned on, and the router will use the best available route to the remote network. This feature will shift network traffic away from a gateway that is working but has degraded performance. Third, EIGRP supports several autonomous systems by labeling each route with an autonomous system identifier. This allows two hostile organizations to run EIGRP more easily in the same environment, and it allows exterior gateways to use only trusted autonomous systems when updating their tables.

Another type of distance vectoring protocol is the DECNet routing system. In a DECNet system, point-to-point links use a reliable transport (e.g., transmission control protocol (“TCP”)) for the primary triggered update. On a local area network (“LAN”), the DECNet primary algorithm uses unreliable broadcasts, which occur every ten seconds. The system uses periodic HELLO messages to poll if a neighbor is present. If a neighbor disappears, after a certain number of HELLO messages, the neighbor's entire routing table database is dumped. Because DECNet maintains a separate routing table database for each neighbor, the remaining neighbor tables are used immediately to make routing decisions when a failed neighbor table is dumped.

The more common type of routing protocol today is the link-state protocol. The most popular protocols of this type are ISIS and OSPF. In these systems each router senses the state of its links with a periodic HELLO message. When a link goes down or comes up, the router initiates a multi-hop flood (reliable flood in OSPF) to the other routers to inform them of the change in link state. Because each router has the state of every link in the local area, it therefore knows the full network graph, and each router can run a shortest-paths graph-search algorithm to find the next hop for each destination in the network.

The reliable flood and full network graph search algorithm solves the problem of counting to infinity that occur in the distance-vectoring protocols. In addition, these protocols also include features to support multi-level hierarchical routing (with N or 2 layers, respectively), and they also include features to elect leaders and reduce HELLO traffic on bus networks with many routers attached. Importantly, however, these protocols include fixed or negotiated time periods that do not allow different routing periods to be associated with different types of routed data.

A third type of conventional system is the Application-Layer router. In these systems, significant network traffic is typically required. The Clearinghouse system initially used an email system for its primary updates. Its secondary updates were performed by selecting a random remote node and doing a side-by-side comparison of each object (checksum and timestamp) in the database. This algorithm was later optimized by favoring nearby neighbors in the random selection algorithm.

The Akamai Freeflow system is a combination of on-demand routing and push or content distribution routing. The FreeFlow network consists of several thousand Akamai hosts that are present in ISPs distributed worldwide. This system distributes HTTP files with MIME types.

Periodically, Akamai will use the Internet multicast protocols to replicate copies of HTTP content files in some of these servers. One advantage of using the multicast protocols for certain high-use content (versus pulling the content from a data cache) is that the network load on the central Akamai servers can be balanced over time. Additionally, the multicast protocols are presently more bandwidth-efficient than caching hierarchy.

For live real-time streaming video events, Akamai employs a fault-tolerant redundant distribution scheme. In this system two copies of the video stream are forwarded through intermediate Akamai node pairs and onwards to each Akamai server, which receives two copies of each packet. This transport mechanism is separate from the IP multicast protocols present in routers.

In addition to these periodic push replication techniques, the Akamai servers also behave like network caches by accepting HTTP requests and either pulling data from an origin server or from their own disk cache. Akamai has a uniform resource locator (“URL”) translation compiler known as the “akamaizer” that reprocesses web page URLs to point to Akamai name servers that know the full internet graph topology. As a result, when web content is fetched, the Akamai name server redirects the request to the closest local Akamai content server. As a result, fetches from corporate web sites that have been akamaized perform as if the corporate name server and corporate web server exist at your local ISP.

Accordingly, the demands of the industry and the failure of the existing solutions have created a need for a routing system that runs at a low level and provides nodes in the network with routing information, protocol configuration information, address translation information, directory service information, boundary information, geo-location information, network/routing clocking information, and power consumption information.

### SUMMARY

Described herein are systems and methods for routing communication packets over wireless and wired networks. Routing may be implemented at either the MAC layer or the Internet layer. Communication packets that are routed include both application data and objects containing network optimization parameters that are used to control the physical links (e.g., radio) in the network. This routing protocol is partitioned into two pieces, a data-transport sub-layer and an open object definition sub-layer. The routing system includes a triggered unreliable update mechanism, and a periodic reliable update mechanism to propagate routing information throughout the network and recover from packets lost in the network. The system provides a clean separation between the routing transport protocol and the objects to be routed. Advantageously, new types of objects can be defined and propagated throughout the routing system, including information that has no relationship to network topology or link performance parameters.

Additionally, the routing system allows the period for the periodic reliable update mechanism to be defined on a per-object basis. In addition, the update algorithm can perform an exponential backoff to reduce network retransmissions for long-lived data. In particular, this mechanism allows long-lived quasi-static data such as virus scan patterns to be distributed efficiently by the routing network. Network clients can define new object types of arbitrary size that can be propagated around the network to increase reliability and increase efficiency in the network. Network clients can also supply the read/write storage functions for objects, and manage the reconciliation of missing updates. In particular, these mechanisms allow a high-precision timestamp (e.g., millisecond or higher accuracy) to be defined as an object to be routed by the system.

In addition, the routing system provides for a voting process to be used to reconcile updates to the timestamp, resulting in a high-precision clock synchronization method. The system allows updates to be linked to one another as the rows of a relational database are related to each other. Clients may therefore query a local routing table or the network for information based on this linkage. As a result, different types of MAC addresses can be linked together with attribute data to create an efficient implementation of a distributed bridge. Such a bridge may be either wired or wireless.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a high level network diagram of an example wired, wireless, or hybrid network topology according to an embodiment of the present invention;

FIG. 2A is a block diagram illustrating an example routing device according to an embodiment of the present invention;

FIG. 2B is a block diagram illustrating an example routing device according to an embodiment of the present invention;

FIG. 3 is a block diagram illustrating an example protocol stack according to an embodiment of the present invention;

FIG. 4 is a block diagram illustrating an example encapsulated communication packet according to an embodiment of the present invention;

FIG. 5 is a block diagram illustrating an example protocol packet for transferring attribute information between routing devices according to an embodiment of the present invention;

FIG. 6A is a block diagram illustrating an example packet identifier in an attribute routing system according to an embodiment of the present invention;

FIG. 6B is a flow diagram illustrating an example reboot process in an attribute routing system according to an embodiment of the present invention;

FIG. 6C is a flow diagram illustrating an example origination process in an attribute routing system according to an embodiment of the present invention;

FIG. 6D is a flow diagram illustrating an example flooding process in an attribute routing system according to an embodiment of the present invention;

FIG. 6E is a flow diagram illustrating an example attribute update process in an attribute routing system according to an embodiment of the present invention;

FIGS. 7A and 7B are block diagrams illustrating an example distribution system for transporting virus scan patterns from an application service provider to an attribute routing system for distribution throughout a network according to an embodiment of the present invention;

FIG. 8 is a flow diagram illustrating an example process for application of virus scan patterns according to an embodiment of the present invention;

FIG. 9 is a high level network diagram illustrating an example transparent distributed bridge according to an embodiment of the present invention;

FIG. 10 is a high level network diagram illustrating an example wireless mesh network according to an embodiment of the present invention;

FIG. 11 is a high level network diagram illustrating an example brouter connecting two heterogeneous network segments and according to an embodiment of the present invention;

FIG. 12 is a block diagram illustrating an exemplary wireless communication device that may be used in connection with the various embodiments described herein;

FIG. 13 is a block diagram illustrating an exemplary computer system that may be used in connection with the various embodiments described herein.

### DETAILED DESCRIPTION

Certain embodiments as disclosed herein provide for systems and methods for attribute routing in a wireless or wired network. For example, one method as disclosed herein allows for an enhanced MAC layer on a network device to store additional information about a network in an enhanced routing table. The additional information can be dynamically defined and propagated around the network to each network device having the enhanced MAC layer. Furthermore, the enhanced MAC layer provides for multi-hop routing, thus allowing propagation of the enhanced information about the network throughout multiple segments of a local area network (“LAN”), wireless local area network (“WLAN”), or wide area network (“WAN”).

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

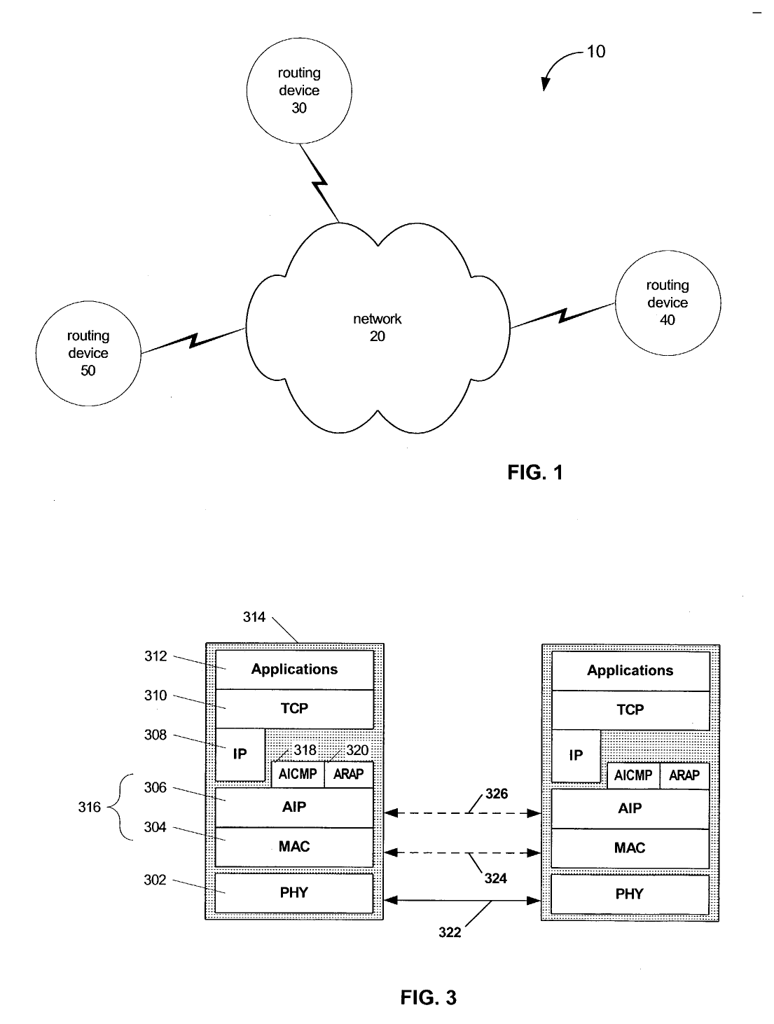

FIG. 1 is a high level network diagram of an example wired, wireless, or hybrid network topology according to an embodiment of the present invention. In the illustrated embodiment, the system 10 comprises a network 20 that communicatively couples a plurality of routing devices 30, 40, and 50.

The network 20 can be a wired network, a wireless network, or a combination of homogeneous or heterogeneous networks including both wired and wireless. Network 20 can be a local area network (“LAN”), a wide area network (“WAN”), or a distributed combination of networks collectively comprising a global communications network such as the Internet. Network 20 can be an ad hoc network or a persistent network and can be fixed in location, mobile, or network 20 may comprise a combination of fixed and mobile components. Additionally, network 20 may carry communications corresponding to a single network protocol or to multiple network protocols. For example, network 20 may carry 802.3 Ethernet traffic and 802.11 wireless traffic.

A routing device is preferably a device that is capable of communication over a communication network such as network 20. For example, routing device 30 can be a personal computer (“PC”), laptop computer, printer, tablet PC, or a wireless communication device such as a personal digital assistant (“PDA”), cell phone, pager, or other device with the ability to communicate data over a wireless network. Preferably, a variety of different routing devices such as routing device 30, 40, and 50 are communicatively coupled via the network 20.

In this detailed description, a routing device such as routing device 30 may be referred to as a network device, network node, routing node, wireless communication device, wireless routing device, and wireless node. Although various names may be used herein, a routing device may comprise all or a minimal subset of the components and functional capabilities described with respect to FIGS. 1-3, 12 and 13.

In one embodiment, routing device 40 can be a sensor device with the ability to send and receive communications over a wired or wireless communication network. For example, routing device 40 may be a smoke sensor that is connected to an in-home wired or wireless communication network. In the event the smoke sensor in routing device 40 detects a fire, it can send a communication over the in-home communication network that would reach the fire department through a connected wide area network. Similarly, the routing device 40 can notify other routing devices connected to the in-home communication network so that each device may sound an alarm, for example.

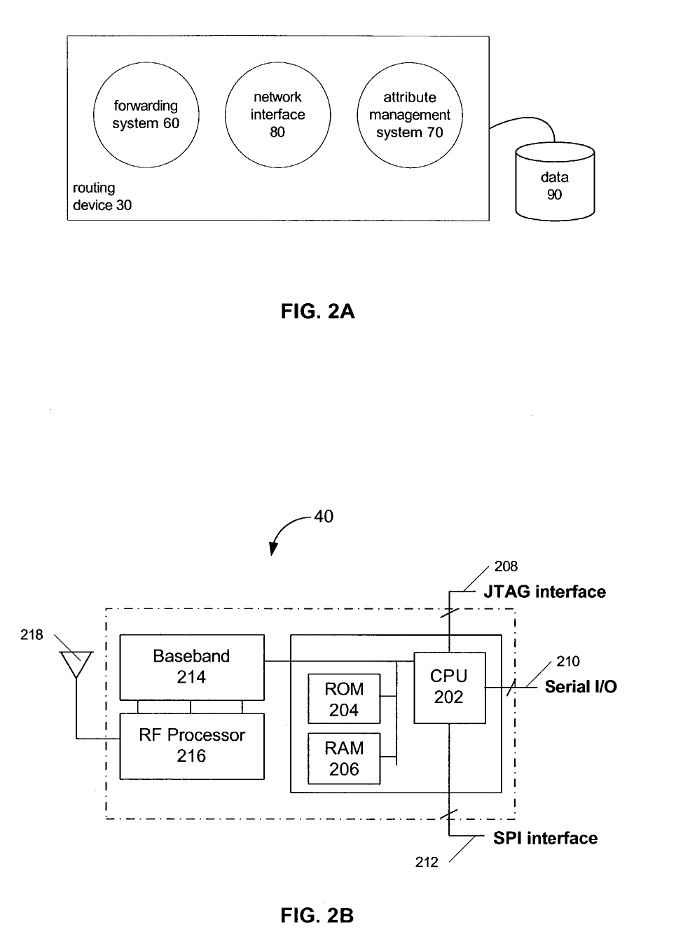

FIG. 2A is a block diagram illustrating an example routing device 40 according to an embodiment of the present invention. In the illustrated embodiment, the routing device 40 comprises a forwarding system 60, an attribute management system 70, a network interface 80, and a data storage area 90. As previously described, the routing device 40 can be any device with the ability to communicate over a wired or wireless network.

The forwarding system 60 is preferably a hardware or software module integrated with the MAC layer of the communication protocol on the routing device 40. Alternatively, the forwarding system 60 may be integrated with the Internet layer of the communication protocol. The forwarding system 60 preferably examines communication packets received from the network and processes those packets or retransmits those packets (or both) as necessary. For example, the forwarding system 60 may receive a communication packet from the network and determine that the packet is destined for another network device. Accordingly, the forwarding system 60 may retransmit the communication packet or discard the packet, depending upon the final destination of the packet.

In one embodiment, the forwarding system 60 provides the communication packet to the attribute management system 70 for further processing. In such an embodiment, for example, the attribute management system 70 may parse the communication packet to obtain information relevant to the routing system. Such information is preferably stored in the data storage area 90 by the attribute management system 70.

Furthermore, the attribute management system 70 generally parses a message frame and examines the message header and the data payload contained therein to extract attributes that provide information about routing devices connected to the network, information about the network itself such as link status, and other information related to routing devices, the network itself, and the interaction between the routing devices and the network. This information is preferably stored in data storage area 90 as a plurality of attributes.

The attribute management routing 70 additionally may perform the function of propagating attributes to other routing devices on the network. For example, the attribute management system 70 may periodically retrieve attributes from the data storage area 90 and encapsulate those attributes in a communication packet and broadcast the communication packet on the network for receipt by other routing devices.

The attribute management system 70 may also allow for the creation of new attributes that can be stored in the data storage area 90 and also propagated around the network as previously described. For example, a new attribute related to routing device 40 may be created the attribute management system 70 and stored in the data storage area 90. The attribute can, for example, provide information about the geographic location of the routing device 40. Additionally, the attribute can advantageously provide information about is own update or refresh period. Such information allows the particular attribute to have an optimized update period while other attributes have their own optimized update periods. This customizable update period on an attribute by attribute basis advantageously reduces overall network traffic by increasing the efficiency of propagating the various attributes to the other routing devices in the network.

Correspondingly, the attribute management system 70 may also refresh and manage the attributes stored in the data storage area 90. In one embodiment, this attribute management may include updating attributes with newly received information and data and it may also include deleting certain attributes, for example an attribute that has expired or otherwise been identified as obsolete.

The data storage area 90 preferably is adaptable to store the attribute routing table for the routing device 40. The attribute routing table may include records comprising a plurality of attributes. In one embodiment, the attribute routing table is a relational database providing a plurality of links between the various records in the attribute routing database. Advantageously, these plurality of records and the relational links can be the subject of queries that provide information about single entries in the attribute routing database as well as information about the relational links and the aggregate entries in the attribute routing database. The data storage area 90 may be implemented using persistent or volatile memory, for example, a data cache, a flash memory, or a hard drive, just to name a few options.

FIG. 2B is a block diagram illustrating an example routing device 30 according to an embodiment of the present invention. In the illustrated embodiment, routing device 30 comprises a central processing unit 202, a read-only memory or FLASH memory 204, and a random access memory 206. In some implementations the ROM 204 and RAM 206 may be incorporated into the CPU 202. In addition, the CPU 202 contains a JTAG I/O interface 208, serial I/O pins 210, and an SPI-bus interface 212 allowing other computer systems to interact with and control the routing device 30.

In the illustrated embodiment, the CPU 202 communicates with a baseband processor 214 that produces radio MAC transactions that are modulated by an RF processor 216 connected to an antenna 218, thereby producing radio waves. In an alternative embodiment, the CPU 202 may communicate with an Ethernet, Token-Ring, or Token Bus network interface card (“NIC”) (not shown) rather than the radio baseband processor 214. In another embodiment the CPU 202 may communicate with many network interfaces (e.g., two radios and three wired networks) at the same time.

FIG. 3 is a block diagram illustrating an example protocol stack 314 according to an embodiment of the present invention. The protocol stack is preferably employed by the various routing devices that participate in autonomic networking and attribute routing. In the illustrated embodiment, the protocol stack has a physical layer 302, a MAC layer 304, an attribute internet protocol (“AIP”) layer 306, an internet protocol (“IP”) layer 308, a transport control protocol (“TCP”) layer 310, and an application layer 312. These layers generally correspond to the TCP/IP layering model and comprise a full protocol stack 314, as will be understood by those having skill in the art.

The physical layer 302 can be any of a variety of physical media. For example, physical layer 302 can be a copper wire or optical cable that transports 802.3 compliant frames. Alternatively, the physical layer 302 can be a wireless link that transports 802.11 compliant frames. In one embodiment, the physical interface for physical layer 304 can be a wireless transceiver that is compliant with 802.11 or 802.15.4. Additionally, narrowband, ultra-wide band (“UWB”), bluetooth, and other wired and wireless physical networks may also be employed. Generally, any type of physical layer can be used with the protocol stack. The physical layer allows peer-peer communications 322 to occur with the physical layer on another routing device.

The virtual MAC layer 316 comprises a single hop routing and communication module 304, a multiple hop routing and communication module 306, an attribute-internet control message protocol (“AICMP”) module 318, and an attribute routing adaptation protocol (“ARAP”) module 320. In one embodiment, the MAC 304, AIP 306, AICMP 318, and the ARAP 320 modules can be implemented as a single module. Alternatively, these modules may be discrete modules or selectively combined to optimize processor use, memory, or other device or network resources.

Within the virtual MAC layer 316, the MAC sub-layer 304 allows peer-to-peer communications 324 to occur with the MAC sub-layer on another routing device. Similarly, the AIP sub-layer 306 allows peer-to-peer communications 326 to occur with the AIP sub-layer on another routing device. The virtual MAC layer 316 interfaces with the IP layer and is preferably configured to emulate the various different MAC transactions that are typically associated with a particular physical layer 302. Thus, although the actual physical layer 302 may be a wireless 802.11 network, the virtual MAC layer 316 can emulate a wired 802.3 network so that the IP layer seamlessly operates as if it was deployed on a network device connected to an 802.3 Ethernet, for example.

In one embodiment, the virtual MAC layer 316 is configured to carry other routing protocols such as RIP or ISIS. Similarly, a router may be connected to the virtual MAC layer 316 and translate packets between the RIP and ISIS protocols. Advantageously, the ability to carry other IP routing protocols significantly increases the portability and usefulness of the network device when connected to other systems, for example when deployed on a network segment using a different routing protocol.

Furthermore, the virtual MAC layer 316 can also be configured separately or in combination to carry other non-IP based protocols such as LonWorks, BACNet, and FieldBus, just to name a few. The ability to carry other protocols advantageously increases the portability and usefulness of the network device when connected to other systems.

The AICMP module 318 preferably provides error reporting to the virtual MAC layer 316. For example, the AICMP module 318 may initiate communication packets to be sent over the physical network when a routing loop is detected in the virtual MAC layer 316, causing a route to be deleted or corrected in the routing tables of a remote node.

The ARAP module 320 preferably maintains and updates an attribute routing table. The attribute routing table preferably contains information related to the local network segment as well as the wider area network and the various network devices connected those networks. The ARAP module 320 is preferably configured to create new attributes that can be included in the attribute routing table. Additionally, the ARAP module 320 is preferably configured to update attributes when remote changes are made, and delete attributes from the attribute routing table when a timeout occurs.

The ARAP module 320 can maintain the attribute routing table by parsing communication packets received from the network to obtain attributes that are included in the message frame header or data payload. These attributes can then be added to the attribute routing table if they are new or the existing data for the attribute can be updated with the data from the recently received communication packet. Additionally, the ARAP module 320 can query the attribute routing table in a local data storage area and propagate the various attributes from its attribute routing table to other network devices in the local network segment or wider area network or networks.

Advantageously, the attribute propagation and attribute update module 320 can query its attribute routing table using multiple indices or keys. In one embodiment, a record in the attribute routing table can be uniquely identified by more than one key. For example, a record in the attribute routing table can be uniquely identified by the IP address of a network device or by the geographic location (e.g., GPS location) of a network device. Advantageously, the IP address and the geographic location are attributes in the attribute routing table. Other attributes may include the maximum transmission unit (“MTU”), time of day, signal strength, antenna sector, fault tolerance indication (high frequency attribute propagation (“HFAP”)), default route, default name service, node altitude, time zone, time slot, system identification, sensor type, virus pattern, DNS or NETBIOS name, or any other standard or customizable data point for a network device or network.

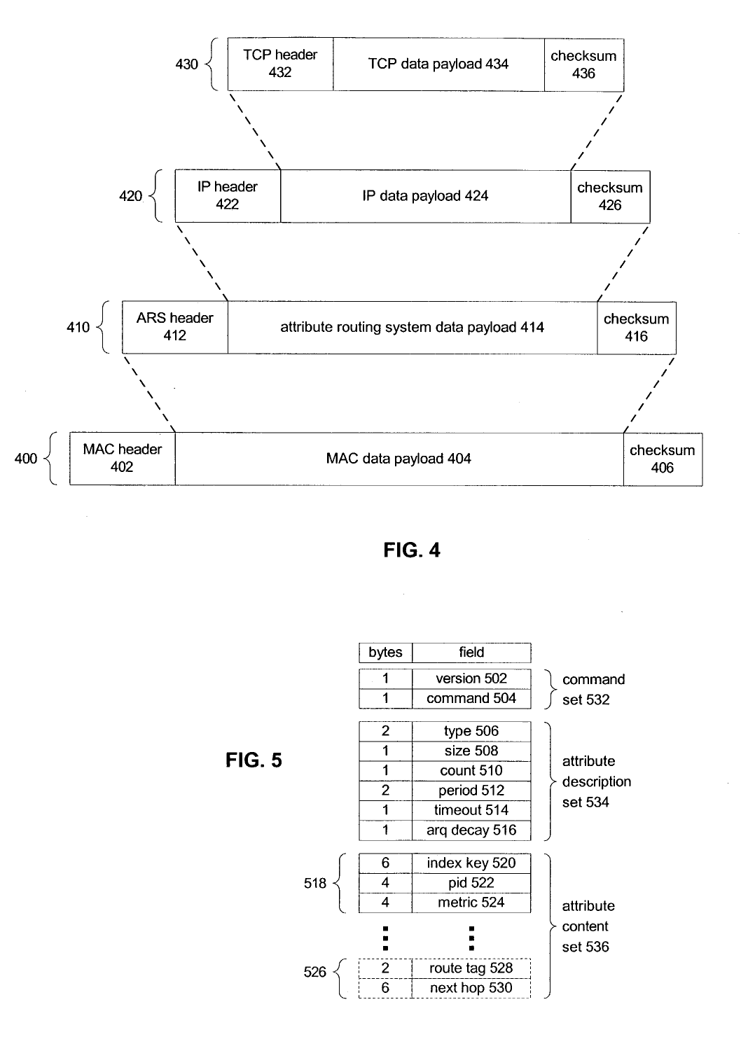

FIG. 4 is a block diagram illustrating an example encapsulated communication packet according to an embodiment of the present invention. In the illustrated embodiment, the set of hierarchical communication packets includes a MAC layer message frame 400, an attribute routing system message frame 410, an IP layer message frame 420, and a TCP layer message frame 430.

The MAC layer message frame 400 comprises a MAC header 402, MAC data payload 404, and a checksum 406. The MAC header 402 preferably contains information related to the physical network medium in addition to other information. As will be understood by those having skill in the art, the attribute routing message frame 410 is encapsulated in the MAC data payload 404. The MAC data payload 404 may contain other data in addition to the attribute routing message frame 410. The MAC checksum 406 preferably allows for the message frame to be validated and verified as delivered intact, as is well understood in the art.

The attribute routing system message frame 410 similarly comprises an AIP header 412, an AIP data payload 414, and a checksum 416. Advantageously, the AIP header 412 may contain information related to error messages and other status of a node or network segment. The AIP header 412 may also contain certain attribute information. Also, the AIP data payload 414 preferably contains attribute objects and other attribute information. Additionally, the AIP data payload 214 comprises the IP message frame 420. The AIP checksum 416 preferably allows for the message frame to be validated and verified as delivered intact.

The IP message frame 420 comprises an IP header 422, an IP data payload 424, and an IP checksum 426. The IP data payload 424 comprises the TCP message frame 430 and other data. The IP checksum 426 preferably allows for the message frame to be validated and verified as delivered intact. The TCP message frame 430 comprises a TCP header 432, a TCP data payload 434, and a TCP checksum 436. The TCP data payload 434 typically comprises data for applications that run on the network device and the TCP checksum 436 allows for the message frame to be validated and verified as delivered intact.

FIG. 5 is a block diagram illustrating an example protocol packet for transferring attribute information between routing devices according to an embodiment of the present invention. In the illustrated embodiment, the basic structure of an autonomic/adaptation routing packet is shown comprising three sets of fields, the command set 532, attribute description set 534, and attribute content set 536.

Advantageously, this illustrated protocol packet is able to route attributes that allow many classes of data to be sent through the system. For example, the packet can emulate a RIP-1 type of MAC-layer protocol or a RIP-2 type of MAC-layer protocol. The command set 532 is commonly found in most protocols including RIP and IP. The version field 502 uses one byte of storage. The content of the field can be the number one (1), although other versions and perhaps future versions may use the number two (2), the number three (3), and so on. The command field 504 can represent a request protocol packet or a response protocol packet. In one embodiment, a request packet can be indicated with the number one (1) while a response packet can be indicated with the number two (2). This field uses one byte of storage.

The attribute router in theory can define up to 65536 different types of attributes. Thus, the attribute type field 506 uses two bytes of storage. Advantageously, attributes can be identified by the content of the attribute type field 506. there is one special attribute type. The attribute type zero (0) may be used in a request packet to request a replay of all attributes of all types in the database. In some cases, the size of each attribute's index keys may vary depending upon the attribute type. For example, IP keys might require 4 bytes, and 802 MAC address keys might require 6 bytes. In this case, the highest bits of the attribute type may be used to indicate the index key size (e.g. 1, 2, 4, 6, 8 bytes, etc.) In what follows we assume a 6-byte key, but do not preclude other key sizes in our system.

In one embodiment, each attribute transfer message comprises a series of variable or fixed sized records and the size of each record is stored in the attribute size field 508. For example, an attribute size of zero may indicate that records are null-terminated, allowing variable-length strings to be stored as attributes. This is particularly important for distributing virus scan patterns or variable-length name records. In a request or response message, more than one attribute can be requested or returned, and so the attribute count field 510 indicates the number of attributes to be transferred. If there are too many attributes to fit into a single packet, additional packets can be sent with the same command set 532 and attribute description 534 but with an updated attribute count field 510 to reflect the number of remaining attributes.

Additionally, each type of attribute has a customizable update period (in seconds or some multiple of seconds) that is defined by the period field 512. The update period, denoted by the symbol π, indicates the number of seconds before all attributes of that type are retransmitted to neighboring router nodes. Related to the update period field 512 is the timeout period field 514, denoted by the symbol τ. The content of the timeout field 514 is typically an integer that is later multiplied by the content of the update period field 514 to arrive at the actual timeout value. For example, to implement a RIP-like protocol the period field 512 might be 30 and the timeout field 514 might be 6. Thus, attributes time out and disappear from the system if they are not refreshed within 180 seconds (i.e., 6*30 seconds.).

The final field in the attribute description set 534 is the ARQ decay field 516, denoted by the symbol α. If the value of the ARQ decay field 516 is one or zero, then all attributes of the given type are transmitted in every period as in the RIP or OSPF protocols. If the value is greater than one (1), then the forwarding and timeout processes in the attribute router support the transport of large, slowly changing databases, such as a name server database or a virus scan pattern database. This field also provides the routing system with the ability to perform an exponential backoff when a network media is overloaded, beneficially enhancing transport reliability.

In an exemplary embodiment, each attribute in the database has an associated age value, denoted by the symbol χ, indicating the elapsed time since the attribute last changed its value at a node. If α>1 then the retransmit probability of an object of age π(α^{ι-1})<χ≦π(α^{ι}) is (1/α)^{ι}. For example, if α=2, then objects with age 0<χ≦π have a retransmit probability 100%. Objects whose age is between π and 2π have a retransmit probability 50%. Objects whose age is between 2π and 4π have a retransmit probability 25%. Objects whose age is between 4π and 8π have a retransmit probability 12.5%, and so forth. This will produce infinitely many retransmissions but the offered load on the network per object will decay exponentially as objects age without changing values. In a similar fashion, if α>1 then the chance of object timeout will be τ(1/α)^{ι} for objects of age π(α^{ι-1})<χ≦π(α^{ι}). This ensures that objects experiencing retransmission decay do not experience an increased chance of timeout.

After the fields of the attribute description set 534, a protocol packet next includes multiple attribute content fields 536. In one embodiment, the set of attribute content fields 536 is restricted to the subset 518. In such an embodiment, the protocol packet advantageously emulates the RIP-1 routing algorithm with IEEE 802 MAC-layer addressing. This record includes a six-byte index key field 520, a packet identifier (“PID”) 522, and a distance metric field 524.

The packet identifier is used to identify and remove stale attribute records. Every new generation of routing object increments this field by the item timeout value (e.g. 180 seconds for RIP), rounded up to the next power of two (e.g. 256), plus the timeout. Every time a message is forwarded, or every second that a message lives within a router, the field is decremented by one. When the generation underflows (e.g. for RIP, when the lower 8 bits change from 0x00 to 0xFF) the object is expired and kept in the routing database as a “dead object” for the timeout period.

This attribute allows the system to implement a routing algorithm very similar to the RIP-1 routing algorithm. For improved performance a route tag field 528 and a next hop field 530 may be included (collectively shown as subset 526, producing a routing algorithm very similar to the RIP2 routing algorithm. Advantageously, in a MAC-layer routing system there is no need for a network mask in the routing records since route summaries are generally not possible.

A request message follows the same format as a response message with one exception. If a request message is generated with an attribute count of zero, then the entire collection of attributes of the given type is returned. Additionally, if the request message is generated with an attribute count of zero, and an attribute value of zero, then the entire collection of all attributes of all types is returned. Otherwise, each index key field 520 in each routing record is populated and used to generate the response. This has the beneficial effect that the same packet buffer received in a request packet can be used for the response packet, avoiding the need to recover from packet allocation errors on small processors.

Advantageously, no form of MTU discovery or negotiation is needed because each router node knows the MTU for each physical interface that it supports. Preferably, each router node on a given network will support the same MTU.

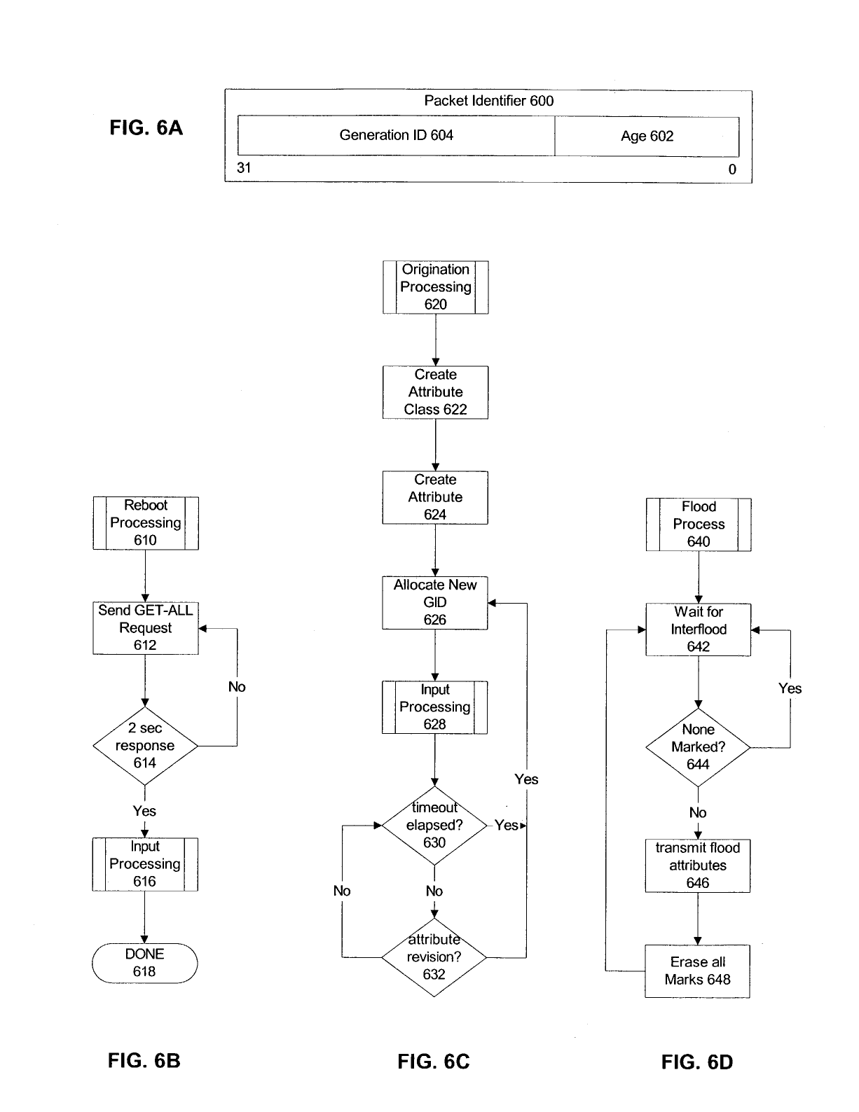

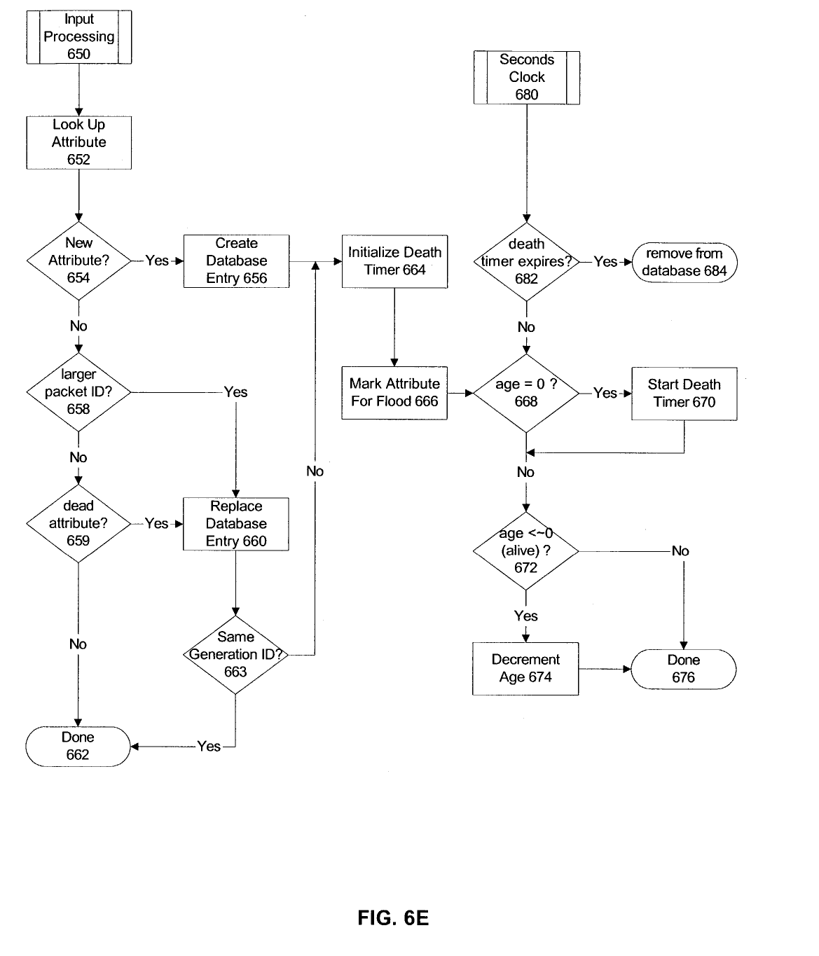

FIG. 6A is a block diagram illustrating an example packet identifier 600 in an attribute routing system according to an embodiment of the present invention. In the illustrated embodiment, the PID 600 is logically divided into two parts. A variable number of lower bits comprise an age field 602. The upper bits comprise a generation identifier (“GID”) 604. The number of bits is calculated by rounding up the attribute timeout to the next power of two (e.g. 180 seconds for RIP rounds up to 256, or 8 bits for age.) An attribute is considered dead if the age field 602 is all 1's in binary notation.

FIG. 6B is a flow diagram illustrating an example reboot process in an attribute routing system according to an embodiment of the present invention. Initially, at system reboot time 610, a request is broadcast to get all attribute records from the neighboring routers 612. This is accomplished by asking for all records of attribute zero, as previously described with respect to FIG. 5. If there is no response within a few seconds the request is rebroadcast 614. When the response is received it is processed using the input processing 616 algorithm that will be described in FIG. 6E.

FIG. 6C is a flow diagram illustrating an example origination process in an attribute routing system according to an embodiment of the present invention. To originate an attribute 620 a client creates an attribute class 622, and then instantiates the attribute record 624. This causes a new generation ID to be allocated 626 and the attribute is handled by the input processing algorithm 628 to be described in FIG. 6E. At that point the attribute exists in the system until either the attribute period expires 630, whereupon the system allocates a new generation ID 626 and the system re-inputs the attribute 628, which will trigger the forwarding machinery. If an attribute originator modifies an attribute, the attribute manager increments the generation ID 626 and re-inputs the attribute, causing an immediate flood 628.

FIG. 6D is a flow diagram illustrating an example flooding process in an attribute routing system according to an embodiment of the present invention. In the illustrated embodiment, the flood process 640 initially waits for the inter-flood period 642, which can be specified in seconds by the protocol, and then checks all attributes 644 to see if there are any marked for flooding. If there are no attributes marked for flooding, the process goes back to sleep 642. Otherwise, the flood process transmits all such attributes 646 and clears the marks 648. If the all the changed attributes do not fit into a single packet, then additional packets are sent using duplicate attribute type descriptors. These two operations 646 and 648 can be handled as a single atomic transaction.

Each router has a means, dependent on the attribute type, to identify attributes that it has originated in the past. For example the originating router address could be stored within each attribute. For each of these attributes the router learns the most recent packet ID that was in use before its last restart and updates its tables appropriately. If possible, the router stores the packet ID number in flash and may use this packet ID in preference to learning the ID from a remote router. Preferably, this packet ID learning algorithm is always active in every router.

FIG. 6E is a flow diagram illustrating an example attribute update process in an attribute routing system according to an embodiment of the present invention. In the illustrated embodiment, when an attribute is received from the network 650, it is looked-up in the database 652. If it does not exist 654, a new database entry is created 656. If it exists and the one in the database has a lesser packet ID 658, the new attribute replaces the existing database entry 660. If the existing attribute is a dead object 659, meaning that the age field is all 1's (=˜0), then the new attribute replaces the existing database entry 660. If none of the three conditions are true, then the old duplicate attribute is discarded 662. Next, the new attribute generation ID is compared to the replaced generation ID 663, and if they are equal (meaning the new object is a younger version of the same object), the process completes.

Otherwise, for a new attribute object/version, the death timer is initialized 664 based on its status as dead or alive, and the attribute is queued for flooding 666. Then the age is tested 668 to see if death is imminent. If it will die then the death timer is started 670. Then, if the attribute is still alive 672 the age is decreased by one 674. In one embodiment, when the age underflows, the attribute is considered dead. Once the age of an attribute is decreased, the input process is complete 676.

The seconds ticking process 680 performs aging on attributes that are not being forwarded. First the death timer is examined to see if it has expired 682. If it is expired, then the item is removed from the database 684. Otherwise, the age is increased 682, as previously described with respect to the input processing algorithm in FIG. 6B.

In one embodiment, when the generation ID increases to the maximum value then all attributes are purged from the system and the system is reinitialized with new attributes with a low-numbered packet ID. The origin router performs this by avoiding the use of the highest few packet IDs. When the packet ID approaches these high-numbered packet IDs, a dead packet ID is sent with a deleted age to erase all the existing attributes from the system. When this has been done it is now possible to reset the generation ID to zero and begin anew.

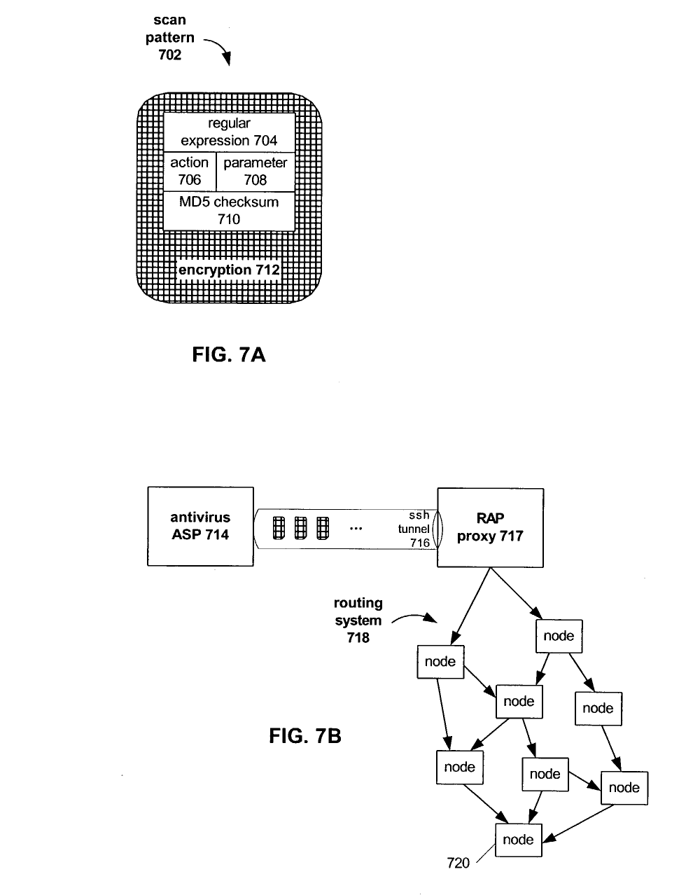

FIG. 7A is a block diagram illustrating an example virus scan pattern 702 according to an embodiment of the present invention. In the illustrated embodiment, the structure of the virus scan pattern 702 comprises a regular expression 704, a scan action 706, and an action parameter 708. The virus scan pattern 702 is digitally signed and therefore has an MD5 checksum 710. The entire virus scan pattern 702 is also encrypted, for example by using a private key to cryptographically authenticate the sender. Thus, the scan pattern 702 is encapsulated in an encryption layer 712. In one embodiment, the scan action 706 may include actions such as delete, substitute, and quarantine.

FIG. 7B is a block diagram illustrating an example distribution system for transporting virus scan patterns from an application service provider (“ASP”) 714 to an attribute routing system 718 for distribution throughout a network according to an embodiment of the present invention. In the illustrated embodiment, the ASP 714 emits one or more scan patterns (such as those previously described with respect to FIG. 7A) to a RAP proxy portal 717. For example, the scan patterns may be distributed through a secure channel such as secure tunnel 716. The RAP proxy 717 subsequently emits the scan pattern attributes, preferably with a short update period. For example, the update period may be set at one minute. Additionally, the scan pattern attributes emitted by RAP proxy 717 preferably have a long timeout period, for example one hour. Finally, the ARQ decay is preferably set to two (2).

The scan pattern emitted by RAP proxy 717 is distributed by the autonomic routing system 718 throughout the network. Advantageously, the inherent reliability of the autonomic routing system 718 ensures that the scan pattern is reliably distributed to even the most remote nodes in the network, such as node 720. Once the scan pattern has been distributed throughout the system, then the message update traffic decays towards zero. To delete an object the ASP injects a null pattern into the system. This null pattern is not refreshed by the ASP, and eventually every object either times out, or is overwritten by the null pattern, which later times out of the attribute routing system 718.

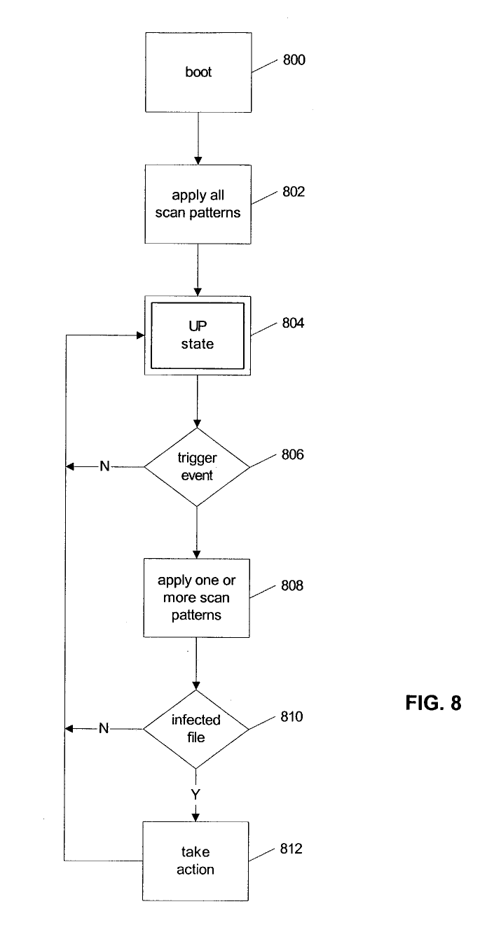

FIG. 8 is a flow diagram illustrating an example process for application of virus scan patterns according to an embodiment of the present invention. The illustrated process may take place within a routing device, a general-purpose computer, a wireless communication device, or some other computing device capable of receiving virus scan patterns. For example, the device may receive the virus scan patterns by a wired or wireless network connection or by some physical media such as a compact disc, or a portable universal serial bus (“USB”) drive.

Accordingly, within the device implementing the illustrated process, the normal operating system state is UP. In arriving at the normal UP state, the device initially must boot, as illustrated in step 800. The device may boot based on a power up, a power cycle, or a reboot in response to a direct command or a fatal system crash. In all cases, when the device is booting up, all of the virus scan patterns stored in persistent memory are advantageously executed, as shown in step 802. The exact timing of the execution of the virus scans may vary depending on the device. For example, the virus scan patterns may be executed after the BIOS boot and early boot but before the operating system boot, as will be understood by those having skill in the art. Preferably, the scan step 802 scans all of the files on the device.

After the device boots up, it remains in the UP state 804 until a trigger event is detected, as shown in step 806. If no trigger event is detected, the device remains in the UP state 804. A trigger event as detected in step 806 may be any of a variety of events. For example, a trigger event may advantageously occur when the device receives a new scan pattern, receives an updated scan pattern, or receives a new file. Additionally, the detection of an unauthorized disk transaction may be identified as a trigger event. In one embodiment, a list of trigger events may be maintained by the device.

Once a trigger event has been detected, in step 808 the device applies one or more of its scan patterns to one or more of the files on the device. For example, if a new scan pattern is received, the device can advantageously apply the new scan pattern to all of its files. Alternatively, if an updated scan pattern is received, the device may apply the updated scan pattern to all files with a timestamp later than the most recent execution of the previous version of the scan pattern.

When the execution of the one or more scan patterns is complete, in step 810 the device determines if any infected files were detected. If infected files were found, the device takes the appropriate action, as illustrated in step 812. Preferably, the action to be taken is defined by the scan pattern, for example the infected file may be deleted, substituted, or quarantined. In an alternative embodiment, the action taken may be interleaved with the execution of the scan pattern so that infected files are processed during the scanning process rather than in a serial fashion.

If no infected files are found, the device preferably returns to the UP state 804. Also, if infected files were found, after the appropriate action has been taken, the device preferably returns to the UP state 804. If additional scan patterns are to be executed, the process may loop back to step 808 (loop not shown) one ore more times until all of the necessary scan patterns have been executed.

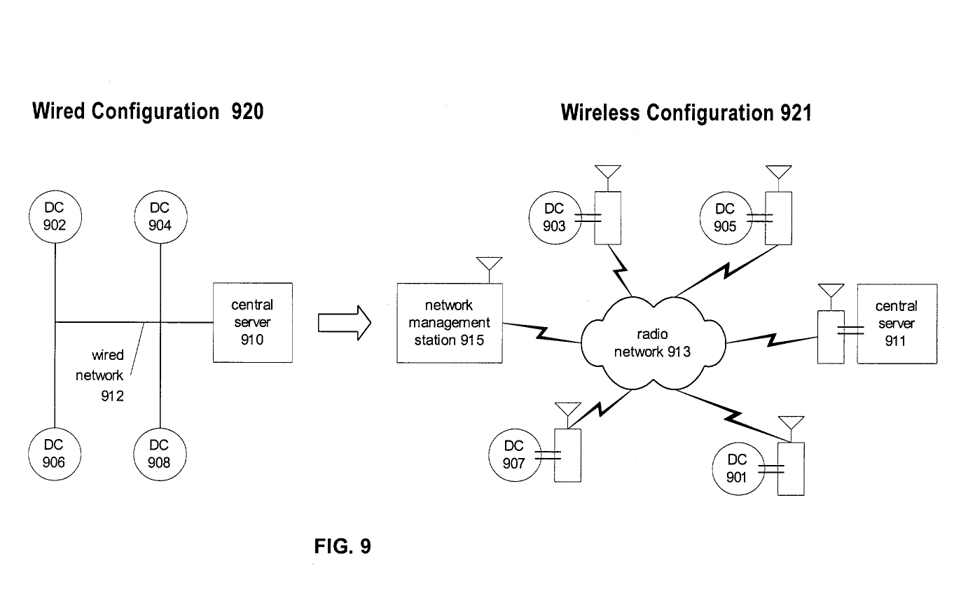

FIG. 9 is a high level network diagram illustrating an example transparent distributed bridge according to an embodiment of the present invention. In the illustrated embodiment, a wired configuration 920 and a wireless configuration 921 are shown. In the wired configuration 920, four device controller stations 902, 904, 906, and 908 are connected with a central server 910 via a traditional multi-drop wired network 912. In the wireless configuration 921, four device controller stations 903, 905, 907, and 909 are connected with a central server 911 and a network management station 915 via a wireless radio network 913. Preferably, each device controller station 903, 905, 907, and 909, the central server 911, and the network management station 915 all contain an attribute routing adaptation protocol system allowing them to associate together in a wireless mesh network that replaces the multi-drop wired network 912.

In one embodiment, the central server 911 and each device controller 903, 905, 907, and 909 provides both power and a network wire to its corresponding radio module, which in turn preferably emulates the behavior of a wired network. The network management station 915 preferably is configured to participate in the wired mesh network 913 to monitor the health of the system. For example, the health of the wireless network 913 may be monitored by the network management station 915 participating as a router node in the wireless network 913. In such a role, the network management station 915 can analyze the various attributes propagated around the network by the attribute routing adaptation protocol. Such an embodiment may be referred to as a distributed bridge system.

A difficult problem in a distributed bridge system is the attendant packet encapsulation and translation that must occur for a communication packet to be forwarded within the distributed bridge. Advantageously, nearly all network communication protocols designed for multi-hop networking provide an IEEE 802 encapsulation (e.g., Ethernet encapsulation) for forwarding or tunneling communication packets through an Ethernet. An attribute routing system that routes at the MAC layer, in particular the IEEE 802 MAC layer, can advantageously emulate an Ethernet and thereby use the Ethernet encapsulation mechanism for packet encapsulation in a distributed bridge system.

Another difficult problem in a distributed bridge system is name translation and/or the implementation of special features associated with a particular protocol such as Ethernet, BACNet, LonWorks, MAP, and TOP, just to name a few. Advantageously, the attribute routing adaptation system can use the attribute transport mechanism to replicate data at each network node, including the MAC ID of the protocol being bridged (a first attribute), and a virtual network number associated with every station (a second attribute). In doing so, name translation and the various protocol specific features can easily be provided in a distributed bridge system.

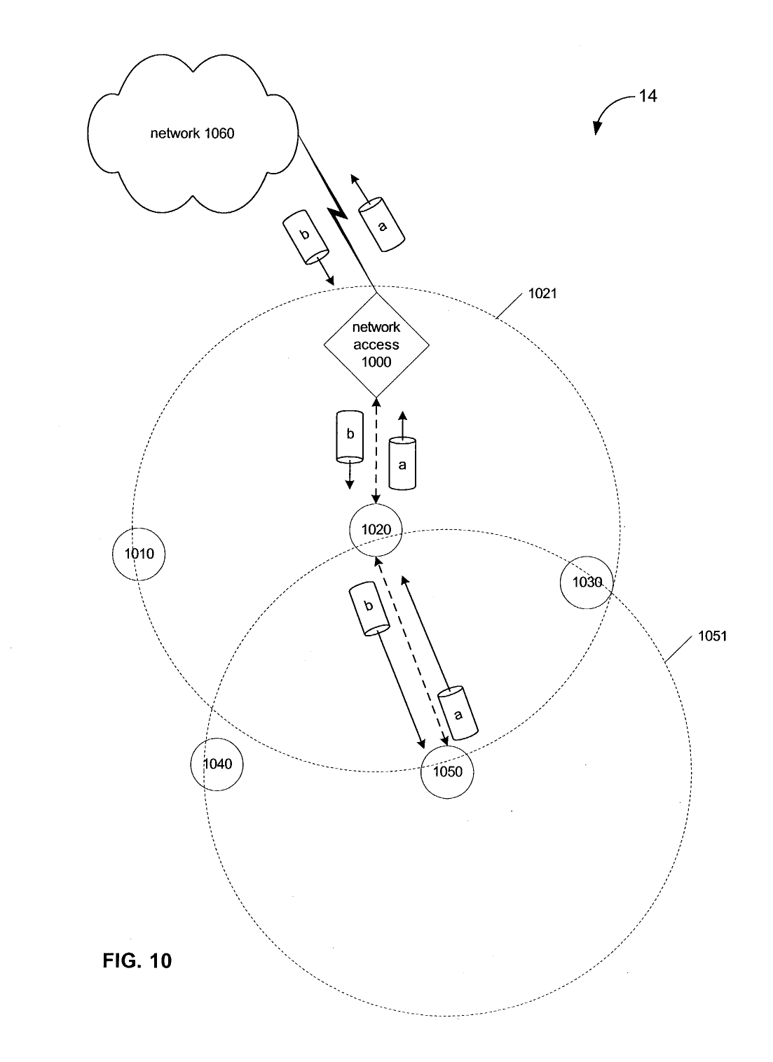

FIG. 10 is a high level network diagram illustrating an example wireless mesh network 14 according to an embodiment of the present invention. In the illustrated embodiment, the wireless mesh network comprises a plurality of wireless communication devices 1010, 1020, 1030, 1040, and 1050. Additional wireless communication devices may also be included in the network 14 and some wireless communication devices may be out of communication for one reason or another, for example device 1010 may be powered down.

Preferably, the wireless communication devices are configured with a radio transceiver or other means of communicating with other wireless devices and over a wireless network. In the illustrated embodiment, wireless communication device 1020, and 1050 each have a corresponding omni directional transmission range 1021 and 1051, respectively. The other wireless communication devices in the network 14 preferably also have an omni directional transmission range, although these are not shown in order to simplify the diagram. As shown, device 1050 is not in range for communication with the network access device 1000, which provides external network access to network 1060, which can be a local area network, a wide area network, or for example, the Internet.

Advantageously, the wireless communication devices in the mesh network 14 are equipped with an enhanced MAC layer that provides the ability for a wireless communication device to perform multiple hop routing of communication packets over a wireless network. For example, device 1050 broadcasts a communication packet A destined for a location that is somewhere within network 1060. The communication packet cannot reach network access point 1000, but it does reach wireless communication device 1020. The MAC layer on device 1020 recognizes the external destination of the communication packet and sends the packet through network access point 1000 for ultimate delivery at its destination within network 1060.

Similarly, when a response communication packet B is sent by network access point 1000, wireless communication device 1020 receives packet B and broadcasts the packet so that it may also be received by wireless communication device 1050. Thus, communication packets can be routed across a plurality of wireless communication devices capable of multiple hop routing at the MAC layer so that network communications from a mesh network are possible with external networks and the corresponding network devices on those external networks.

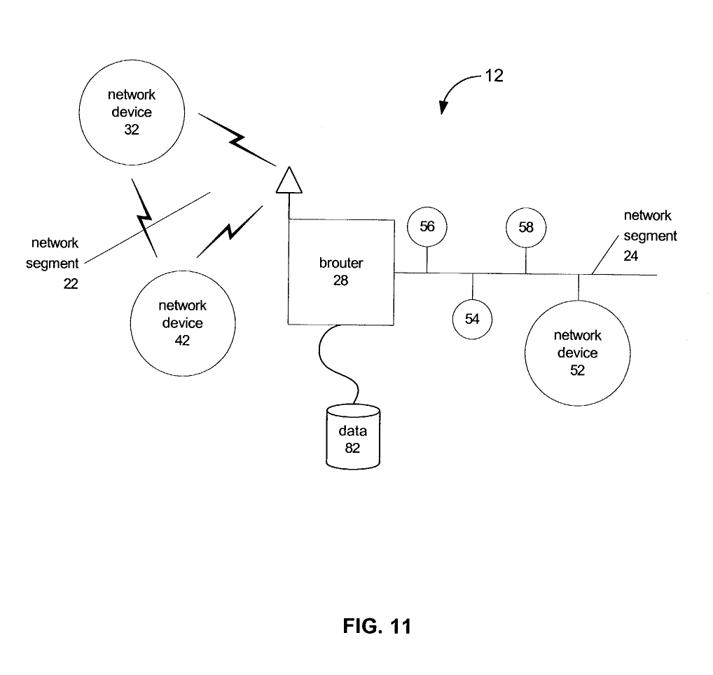

FIG. 11 is a high level network diagram illustrating an example brouter 28 connecting two heterogeneous network segments 22 and 24 according to an embodiment of the present invention. In the illustrated embodiment, network segment 22 is a wireless network, for example an 802.11 network. Additionally, network segment 24 is a wired network, for example an 802.3 network. The two network segments are coupled by a brouter 28 that has an associated data storage area 82. The complete network 12 comprises both network segments 22 and 24 and is logically a single network such that each network device, whether connected to the wireless network segment 22 or the wired network segment 24, has the same network portion for its IP address. Physically, however, the network 12 comprises a wireless network segment 22 and a wired network segment 24 connected by a brouter 28 as illustrated.

The network segment 22 comprises network device 32, network device 42, and brouter 28. Each network device 32 and 42 is configured to communicate over the wireless network segment 22, for example, with a radio transceiver (not shown). Similarly, the brouter 28 is also configured to communicate over the wireless network segment 22, as illustrated by its integral antenna. In one embodiment, the network devices 32 and 42 and the brouter 28 communicate routing information to each other over the wireless network segment 22 using ISIS.

The network segment 24 comprises network devices 52, 54, 56, and 58 along with the brouter 28. Each network device 52, 54, 56, and 58 is configured to communicate over the wired network segment 24, for example with a network interface card (“NIC”) (not shown). Similarly, the brouter 28 is also configured to communicate over the network segment 24, for example through an integral NIC (not shown).. In one embodiment, the network devices 52, 54, 56, and 58 and the brouter 28 communicate routing information to each other over the network segment 24 using RIP.

The brouter 28 uses the data storage area 82 to store an attribute routing database. The attribute routing database preferably contains conventional routing information in addition to enhanced information about the various network devices across the two network segments 22 and 24. To establish the attribute routing database, the brouter 28 may send a broadcast message on each network segment that requests each network device to provide information in response. As the response messages are received by the brouter 28, records in the attribute routing database may be created and populated.

Advantageously, the records in the attribute routing database may be linked together according to their related attributes. Thus, the set of network devices connected to the wireless network segment 22 can be uniquely identified in the attribute routing database, for example, by querying the database for those records with ISIS as the routing protocol. Similarly, the set of network devices connected to the network segment 24 can be uniquely identified in the attribute routing database by querying the database for those records with RIP as the routing protocol.

Additional attributes for network devices and network segments may also be defined and stored in the attribute routing database and various relationships identified based upon the aggregate attributes in the database. Advantageously, new attributes may be defined and stored in an attribute routing database during operation of the network. A significant advantage of this is that each attribute may carry its own unique update period so that the attribute information is propagated around the network at the optimal frequency to maintain accurate information while minimizing network traffic. This optimization can be extremely beneficial to a wireless network such as wireless network segment 22.

Once the brouter 28 has created the attribute routing table and stored the table in data storage area 82, communication packets from a network device on network segment 22 that are destined for a network device on network segment 24 can be transparently passed between the network segments by brouter 28. For example, brouter 28 can receive a communication packet from network device 32, extract the MAC message frame from the 802.11 communication and then encapsulate the MAC message frame in an 802.3 communication packet for delivery to the destination network device, for example, network device 52. Alternatively, the brouter 28 may extract the IP message frame from the communication packet and encapsulate the IP message frame in a MAC message frame oriented for delivery over an 802.3 network such as network segment 24.

Advantageously, the MAC layer on network device 52 may provide an IP message frame to the IP layer on network device 52 such that the IP layer on network device 52 is unaware that the originating network device 32 is connected to wireless network segment 22.

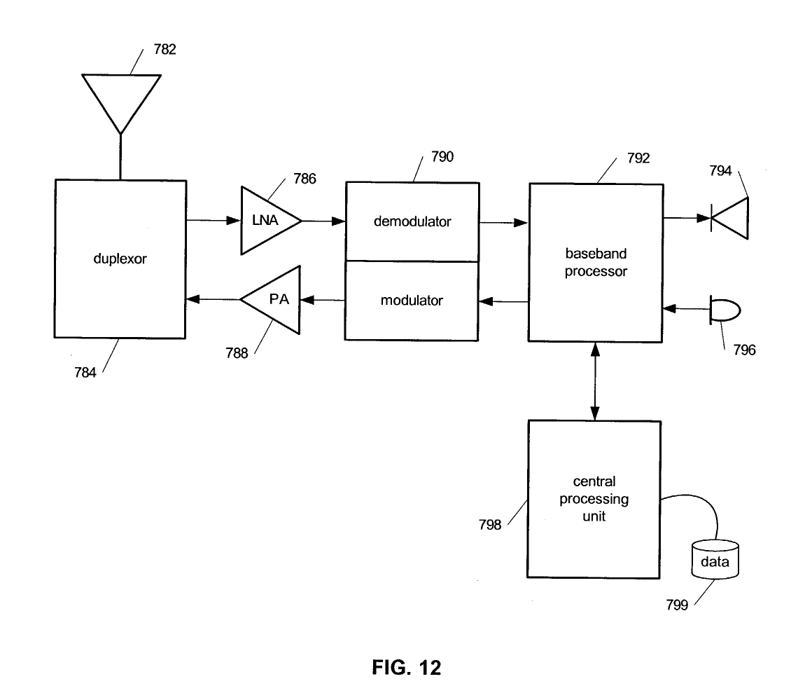

FIG. 12 is a block diagram illustrating an exemplary wireless communication device 780 that may be used in connection with the various embodiments described herein. For example, the wireless communication device 780 may be used in conjunction with a handset or PDA network device or as a part of a sensor node in a wireless mesh network. However, other wireless communication devices and/or architectures may also be used, as will be clear to those skilled in the art.

In the illustrated embodiment, wireless communication device 780 comprises an antenna 782, a duplexor 784, a low noise amplifier (“LNA”) 786, a power amplifier (“PA”) 788, a modulation circuit 790, a baseband processor 792, a speaker 794, a microphone 796, a central processing unit (“CPU”) 798, and a data storage area 799. In the wireless communication device 780, radio frequency (“RF”) signals are transmitted and received by antenna 782. Duplexor 784 acts as a switch, coupling antenna 782 between the transmit and receive signal paths. In the receive path, received RF signals are coupled from a duplexor 784 to LNA 786. LNA 786 amplifies the received RF signal and couples the amplified signal to a demodulation portion of the modulation circuit 790.

Typically modulation circuit 790 will combine a demodulator and modulator in one integrated circuit (“IC”). The demodulator and modulator can also be separate components. The demodulator strips away the RF carrier signal leaving a base-band receive audio signal, which is sent from the demodulator output to the base-band processor 792.

If the base-band receive audio signal contains audio information, then base-band processor 792 decodes the signal and converts it to an analog signal. Then the signal is amplified and sent to the speaker 794. The base-band processor 792 also receives analog audio signals from the microphone 796. These analog audio signals are converted to digital signals and encoded by the base-band processor 792. The base-band processor 792 also codes the digital signals for transmission and generates a base-band transmit audio signal that is routed to the modulator portion of modulation circuit 790. The modulator mixes the base-band transmit audio signal with an RF carrier signal generating an RF transmit signal that is routed to the power amplifier 788. The power amplifier 788 amplifies the RF transmit signal and routes it to the duplexor 784 where the signal is switched to the antenna port for transmission by antenna 782.

The baseband processor 792 is also communicatively coupled with the central processing unit 798. The central processing unit 798 has access to a data storage area 799. The central processing unit 798 is preferably configured to execute instructions (i.e., computer programs or software) that can be stored in the data storage area 799. Computer programs can also be received from the baseband processor 792 and stored in the data storage area 799 or executed upon receipt. Such computer programs, when executed, enable the wireless communication device 780 to perform the various functions of the present invention as previously described.

In this description, the term “computer readable medium” is used to refer to any media used to provide executable instructions (e.g., software and computer programs) to the wireless communication device 780 for execution by the central processing unit 798. Examples of these media include the data storage area 799, microphone 796 (via the baseband processor 792), and antenna 782 (also via the baseband processor 792). These computer readable mediums are means for providing executable code, programming instructions, and software to the wireless communication device 780. The executable code, programming instructions, and software, when executed by the central processing unit 798, preferably cause the central processing unit 798 to perform the inventive features and functions previously described herein.

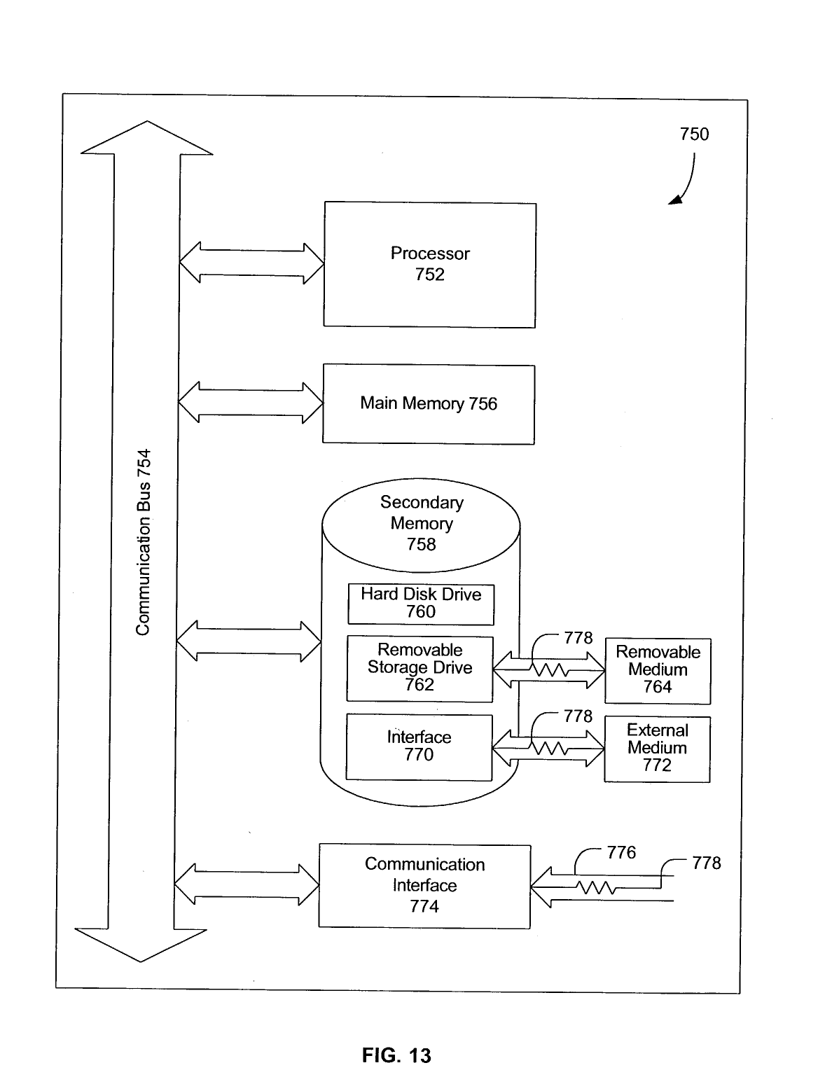

FIG. 13 is a block diagram illustrating an exemplary computer system 750 that may be used in connection with the various embodiments described herein. For example, the computer system 750 may be used in conjunction with a network device, a network access point, a router, a bridge, or other network infrastructure component. However, other computer systems and/or architectures may also be used, as will be clear to those having skill in the art.

The computer system 750 preferably includes one or more processors, such as processor 752. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 752.

The processor 752 is preferably connected to a communication bus 754. The communication bus 754 may include a data channel for facilitating information transfer between storage and other peripheral components of the computer system 750. The communication bus 754 further may provide a set of signals used for communication with the processor 752, including a data bus, address bus, and control bus (not shown). The communication bus 754 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 750 preferably includes a main memory 756 and may also include a secondary memory 758. The main memory 756 provides storage of instructions and data for programs executing on the processor 752. The main memory 756 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 758 may optionally include a hard disk drive 760 and/or a removable storage drive 762, for example a floppy disk drive, a magnetic tape drive, a compact disc (“CD”) drive, a digital versatile disc (“DVD”) drive, etc. The removable storage drive 762 reads from and/or writes to a removable storage medium 764 in a well-known manner. Removable storage medium 764 may be, for example, a floppy disk, magnetic tape, CD, DVD, etc.

The removable storage medium 764 is preferably a computer readable medium having stored thereon computer executable code (i.e., software) and/or data. The computer software or data stored on the removable storage medium 764 is read into the computer system 750 as electrical communication signals 778.

In alternative embodiments, secondary memory 758 may include other similar means for allowing computer programs or other data or instructions to be loaded into the computer system 750. Such means may include, for example, an external storage medium 772 and an interface 770. Examples of external storage medium 772 may include an external hard disk drive or an external optical drive, or and external magneto-optical drive.

Other examples of secondary memory 758 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 772 and interfaces 770, which allow software and data to be transferred from the removable storage unit 772 to the computer system 750.

Computer system 750 may also include a communication interface 774. The communication interface 774 allows software and data to be transferred between computer system 750 and external devices (e.g. printers), networks, or information sources. For example, computer software or executable code may be transferred to computer system 750 from a network server via communication interface 774. Examples of communication interface 774 include a modem, a network interface card (“NIC”), a communications port, a PCMCIA slot and card, an infrared interface, and an IEEE 1394 fire-wire, just to name a few.

Communication interface 774 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 774 are generally in the form of electrical communication signals 778. These signals 778 are preferably provided to communication interface 774 via a communication channel 776. Communication channel 776 carries signals 778 and can be implemented using a variety of communication means including wire or cable, fiber optics, conventional phone line, cellular phone link, radio frequency (RF) link, or infrared link, just to name a few.

Computer executable code (i.e., computer programs or software) is stored in the main memory 756 and/or the secondary memory 758. Computer programs can also be received via communication interface 774 and stored in the main memory 756 and/or the secondary memory 758. Such computer programs, when executed, enable the computer system 750 to perform the various functions of the present invention as previously described.

In this description, the term “computer readable medium” is used to refer to any media used to provide computer executable code (e.g., software and computer programs) to the computer system 750. Examples of these media include main memory 756, secondary memory 758 (including hard disk drive 760, removable storage medium 764, and external storage medium 772), and any peripheral device communicatively coupled with communication interface 774 (including a network information server or other network device). These computer readable mediums are means for providing executable code, programming instructions, and software to the computer system 750.

In an embodiment that is implemented using software, the software may be stored on a computer readable medium and loaded into computer system 750 by way of removable storage drive 762, interface 770, or communication interface 774. In such an embodiment, the software is loaded into the computer system 750 in the form of electrical communication signals 778. The software, when executed by the processor 752, preferably causes the processor 752 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

While the particular systems and methods herein shown and described in detail are fully capable of attaining the above described objects of this invention, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A routing system comprising a plurality of network devices, each network device communicatively coupled with a communication network and having a routing table, the routing table comprising:
a plurality of records, each record comprising a plurality of attributes that provide information unrelated to network topology; and
two or more key attributes, wherein a record in the routing table is uniquely identifiable by one of said two or more attributes.

2. The routing system of claim 1, wherein a record can be simultaneously identified by each of said two or more attributes.

3. The routing system of claim 2, wherein one of said two or more attributes is an IP address.

4. The routing system of claim 2, wherein one of said two or more attributes is a GPS location.

5. The routing system of claim 1 wherein the plurality of attributes comprise network fault tolerance information.

6. The routing system of claim 1, wherein the plurality of attributes comprise high speed attribute propagation information.

7. The routing system of claim 1, wherein the plurality of attributes comprise text data.

8. The routing system of claim 1, wherein the plurality of attributes comprise audio data.

9. The routing system of claim 1, wherein the plurality of attributes comprise video data.

10. The routing system of claim 1, wherein the attributes provide information unrelated to network link performance.

11. The routing system of claim 1, wherein an attribute comprises an update period specific to said attribute.

12. The routing system of claim 11, wherein a plurality of attributes each have a different update period.

13. The routing system of claim 11, wherein the update period of an attribute can be dynamically modified.

14. The routing system of claim 13, wherein an attribute is automatically modified in response to network performance conditions.

15. The routing system of claim 1, wherein a new attribute can be dynamically added to a record in the routing table.

16. The routing system of claim 1, wherein one of the plurality of attributes can be dynamically deleted from a record in the routing table.

17. The routing system of claim 1, wherein one of the plurality of attributes provides information related to time synchronization.

18. The routing system of claim 17, wherein the time synchronization attribute is used to time synchronize a plurality of network devices in the communication network.

19. The routing system of claim 18, wherein the plurality of network devices are battery operated network devices.

20. The routing system of claim 19, wherein the plurality of network devices form a time division multiple access network.

21. The routing system of claim 1, wherein each attribute in a subset of the plurality of attributes provides information relating to a unique routing protocol.

22. The routing system of claim 1, wherein a first attribute provides information relating to the routing information protocol and wherein a second attribute provides information relating to the interior gateway routing protocol.

23. The routing system of claim 1, wherein the routing table is stored in flash memory.

24. The routing system of claim 1, wherein one of the plurality of attributes comprises information related to area throughput in a multi-hop wired network.

25. The routing system of claim 1, wherein one of the plurality of attributes comprises information related to area throughput in a multi-hop wireless network.

26. The routing system of claim 19, wherein the information provided in the area throughput attribute is used to optimize area throughput in the multi-hop network.

27. The routing system of claim 19, wherein area throughput is measured in bits per second per square meter.

28. A network bridge apparatus configured to bridge a first network segment and a second network segment, wherein the first network segment employs a first communication protocol and the second network segment employs a second communication protocol, the bridge comprising:
a routing table having a plurality of records, each record identifying a unique network device on the first or second network segment, wherein each record comprises a plurality of attributes;
a routing management system configured to update the routing table, the routing management system further configured to receive a communication packet from the first network segment and encapsulate the communication packet for delivery to a network device on the second network segment.

29. A routing system comprising a plurality of network devices, each network device communicatively coupled with a communication network, wherein each network device comprises:
a network interface configured to send and receive communication messages over a communications network;
a routing table having a plurality of records, each record comprising a plurality of attributes that provide information related to a particular network device;
an attribute management system configured to update the routing table and propagate attributes to network devices over the communication network; and
a communication management system configured to receive a communication packet from the network interface and provide at least a portion of the content of the communication packet in a format that emulates the media access control layer of a plurality of network types.

30. A network device including a microprocessor, a storage area, and a communication means, the network device configured to route communication packets over a communication network, the network device having a routing table comprising a plurality of records, each record having a plurality of attributes, the network device further configured to create a new attribute, add the new attribute to the routing table, and propagate the new attribute to other network device over the communication network.
